(19) United States
(12) Patent Application Publication
(10) Pub. No.: US 2016/0179582 A1
(43) Pub. Date: Jun. 23, 2016

(54) TECHNIQUES TO DYNAMICALLY ALLOCATE RESOURCES FOR LOCAL SERVICE CHAINS OF CONFIGURABLE COMPUTING RESOURCES

(71) Applicant: INTEL CORPORATION, Santa Clara, CA (US)

(72) Inventors: BRIAN J. SKERRY, Gilbert, AZ (US); IRA WEINY, Livermore, CA (US); PATRICK CONNOR, Beaverton, OR (US); TSUNG-YUAN C. TAI, Portland, OR (US); ALEXANDER W. MIN, Portland, OR (US)

(73) Assignee: INTEL CORPORATION, Santa Clara, CA (US)

(21) Appl. No.: 14/582,084

(22) Filed: Dec. 23, 2014

(51) Int. Cl. G06F 9/50; G06F 9/455

(52) U.S. Cl. CPC G06F 9/5077; G06F 9/45558; G06F 9/5094; G06F 9/5016; G06F 2009/45595; G06F 2009/45591

(57) ABSTRACT

Examples may include techniques to provide performance optimizing of service chains to reduce bottlenecks and/or increase efficiency. Information for performance of virtual elements of a service chain implemented using a shared pool of configurable computing resources may be received. The resource allocation of portions of the configurable computing resources supporting virtual elements of the service chain can be adjusted based on the received information.

### TECHNICAL FIELD

Examples described herein are generally related to configurable computing resources.

### BACKGROUND

Software defined infrastructure (SDI) is a technological advancement that enables new ways to operate a shared pool of configurable computing resources deployed for use in a data center or as part of a cloud infrastructure. SDI may allow individual elements of a system of configurable computing resources to be composed with software. These elements may include disaggregate physical elements such as CPUs, memory, network input/output devices or storage devises. The elements may also include composed elements that may include various quantities or combinations of physical elements composed to form logical servers that may then support virtual elements arranged to implement service/workload elements.

The virtual elements of the SDI can be ordered to form a service chain. In general, each virtual element of the service chain will have differing performance limitations. As a result, a virtual element can become a bottleneck in the overall performance of the service chain.

### BRIEF DESCRIPTION OF THE DRAWINGS

FIG. 1 illustrates an example first system.

FIGS. 2-4 illustrate portions of an example second system.

FIG. 5 illustrates an example third system.

FIG. 6 illustrates an example block diagram for an apparatus.

FIG. 7 illustrates an example of a logic flow.

FIG. 8 illustrates an example of a storage medium.

FIG. 9 illustrates an example computing platform.

### DETAILED DESCRIPTION

As contemplated in the present disclosure, SDI may allow individual elements of a shared pool of configurable computing resources to be composed with software. Service chains can be formed from an ordered set of these virtual elements. Furthermore, a service chain may be classified as a local service chain. As used herein, a local service chain is a service chain comprising two or more virtual elements (e.g., a virtual machine (VM), container, or the like) executing on one physical platform. In some examples, an orchestrator for the cloud infrastructure may attempt to co-locate the virtual elements of a service chain, for example, to reduce latency, minimize traffic over physical links, or the like. Accordingly, local service chains may be formed.

As the various virtual elements of a service chain have differing performance limitations, bottlenecks can form in the service chain. More particularly, each virtual element of the service chain may operate on a pre-allocated portion of the underlying hardware. As the hardware requirements of each virtual element differ, and can change during operation, a virtual element of the service chain can become a bottleneck. For example, a virtual element can become a bottleneck for throughput, latency, power efficiency, or the like.

According to some examples, techniques to dynamically allocate resources to virtual elements within a service chain (or local service chain) to optimize performance of the service chain and reduce bottlenecks are provided. Performance of the virtual elements of a service chain can be monitored. Resources can be allocated or resource allocations can be modified to increase performance of the service chain based on the monitored performance. For example, a performance monitor can determine where the bottlenecks are within a service chain and allocate more resources to the virtual elements causing the bottleneck to increase overall service chain performance.

It is important to note, that the resource allocation can be done dynamically, during operation of the service chain. As such, resource allocation for the service chain can be modified to account for changes in network traffic or computational demands. Furthermore, it is important to note that a variety of resources can be managed, such as, for example, processing components (CPU, GPU, etc.), memory, cache, accelerators, or the like. Additionally, a number of different performance metrics can be optimized, such as, for example, power usage, throughput, latency, or the like.

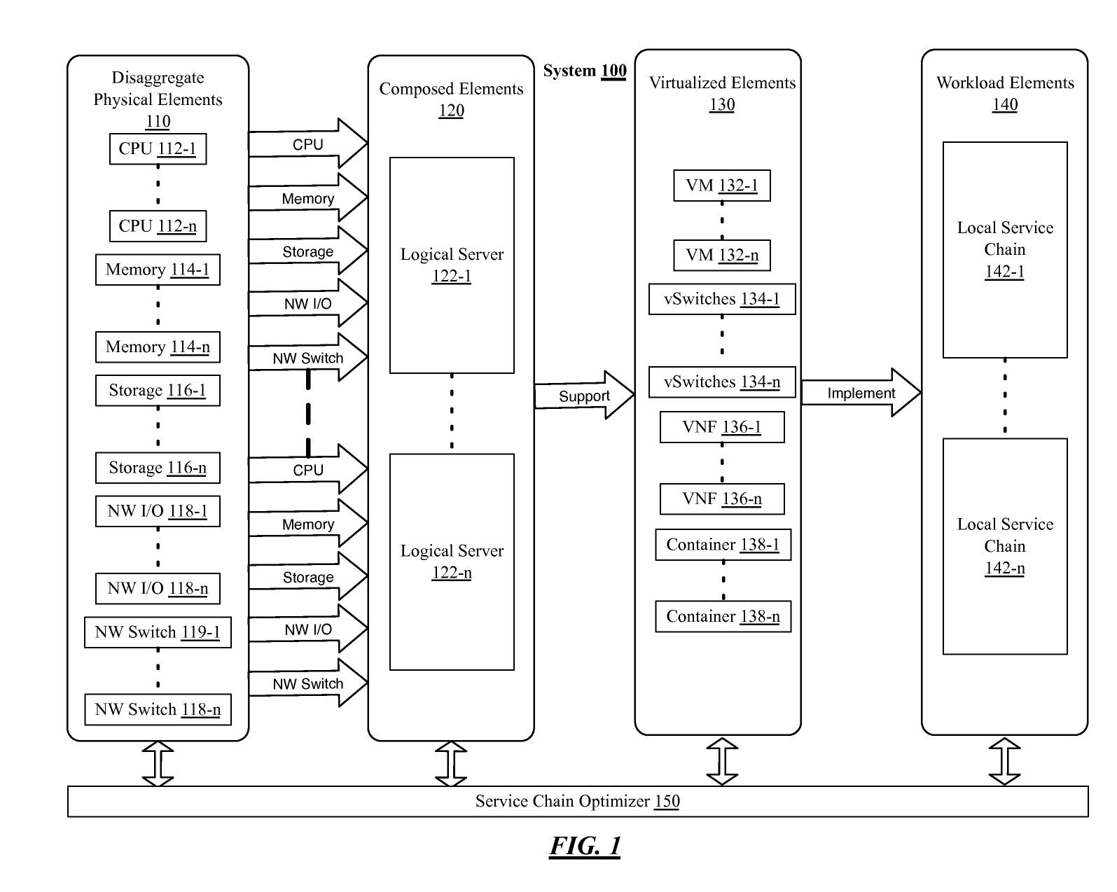

FIG. 1 illustrates an example first system 100. In some examples, system 100 includes disaggregate physical elements 110, composed elements 120, virtualized elements 130, service chains 140, and service chain optimizer (SCO) 150. In some examples, SCO 150 may be arranged to manage or control at least some aspects of disaggregate physical elements 110, composed elements 120, virtualized elements 130 or service chains 140. As described more below, in some examples, SCO 150 may receive information for service chains being provided using a shared pool of configurable computing resources that may include selected elements depicted in FIG. 1. The SCO 150 can manage the allocation of resources to optimize the performance of the service chains 140.

According to some examples, as shown in FIG. 1, disaggregate physical elements 110 may include CPUs 112-1 to 112-n, where “n” is any positive integer greater than 1. CPUs 112-1 to 112-n may individually represent single microprocessors or may represent separate cores of a multi-core microprocessor. Disaggregate physical elements 110 may also include memory 114-1 to 114-n. Memory 114-1 to 114-n may represent various types of memory devices such as, but not limited to, dynamic random access memory (DRAM) devices that may be included in dual in-line memory modules (DIMMs) or other configurations. Disaggregate physical elements 110 may also include storage 116-1 to 116-n. Storage 116-1 to 116-n may represent various types of storage devices such as hard disk drives or solid state drives. Disaggregate physical elements 110 may also include network (NW) input/outputs (I/Os) 118-1 to 118-n. NW I/Os 118-1 to 118-n may include network interface cards (NICs) having one or more NW ports w/ associated media access control (MAC) functionality for network connections within system 100 or external to system 100. Disaggregate physical elements 110 may also include NW switches 119-1 to 119-n. NW switches 119-1 to 119-n may be capable of routing data via either internal or external network links for elements of system 100.

In some examples, as shown in FIG. 1, composed elements 120 may include logical servers 122-1 to 122-n. For these examples, groupings of CPU, memory, storage, NW I/O or NW switch elements from disaggregate physical elements 110 may be composed to form logical servers 122-1 to 122-n. Each logical server may include any number or combination of CPU, memory, storage, NW I/O or NW switch elements.

According to some examples, as shown in FIG. 1, virtualized elements 130 may include a number of virtual machines (VMs) 132-1 to 132-n, virtual switches (vSwitches) 134-1 to 134-n, virtual network functions (VNFs) 136-1 to 136-n, or containers 138-1 to 138-n. It is to be appreciated, that the virtual elements 130 can be configured to implement a variety of different functions and/or execute a variety of different applications. For example, the VMs 132-a can be any of a variety of virtual machines configured to operate or behave as a particular machine and may execute an individual operating system as part of the VM. The VNFs 136-a can be any of a variety of network functions, such as, packet inspection, intrusion detection, accelerators, or the like. The containers 138-a can be configured to execute or conduct a variety of applications or operations, such as, for example, email processing, web servicing, application processing, data processing, or the like.

In some examples, virtualized elements 130 may be arranged to form service chains 140. As shown in FIG. 1, in some examples, service chains 140 may include VMs 132-a, VNFs 136-a, and/or containers 138-a. Additionally, the individual virtual elements of a service chain can be connected by vSwitches 134-a. Furthermore, in some examples, each of the virtualized elements 130 for a given service chain 140 may be supported by a given logical server from among logical servers 122-1 to 122-n of composed elements 120.

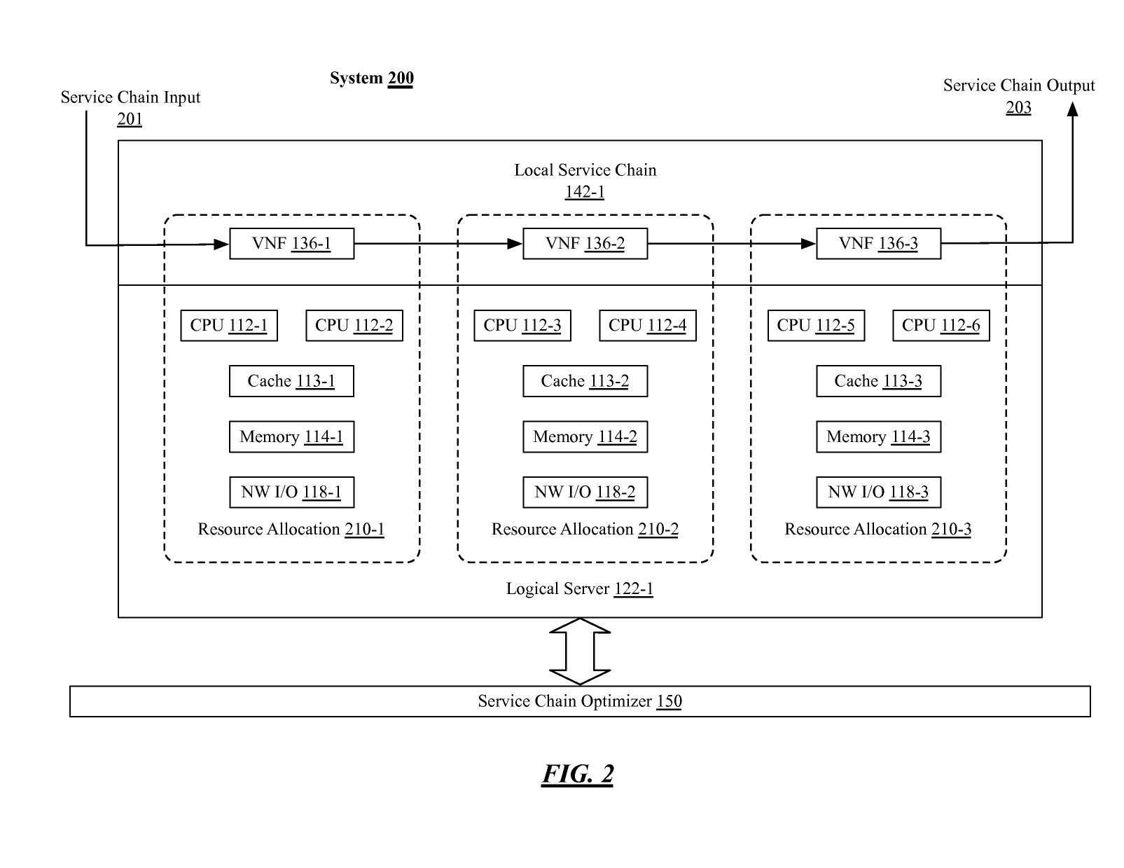

For example, logical server 122-1 (refer to FIGS. 2-5) can be formed from disaggregate physical elements such as CPU 112-1 to CPU 112-6. Local service chain 142-1 can be formed from VNFs 136-1 to 136-3 and can be supported by logical server 122-1. Accordingly, the VNFs 136-a of the local service chain 142-a can be configured to operate using a portion of the computing resources (e.g., CPU 112-1 to 112-6) of the logical server 122-1. Said differently, a portion of the computing resources of the logical server 122-1 can be allocated for each of the virtual elements of the local service chain 142-1

The SCO 150 can be configured to receive performance information for the service chains (e.g., the service chains 142-a) and to allocate (or adjust an allocation of) a portion of the shared pool of configurable resources (e.g., the disaggregate physical elements 110) for any number of the virtual elements (e.g., the virtualized elements 130) that make up the service chains based on the received information.

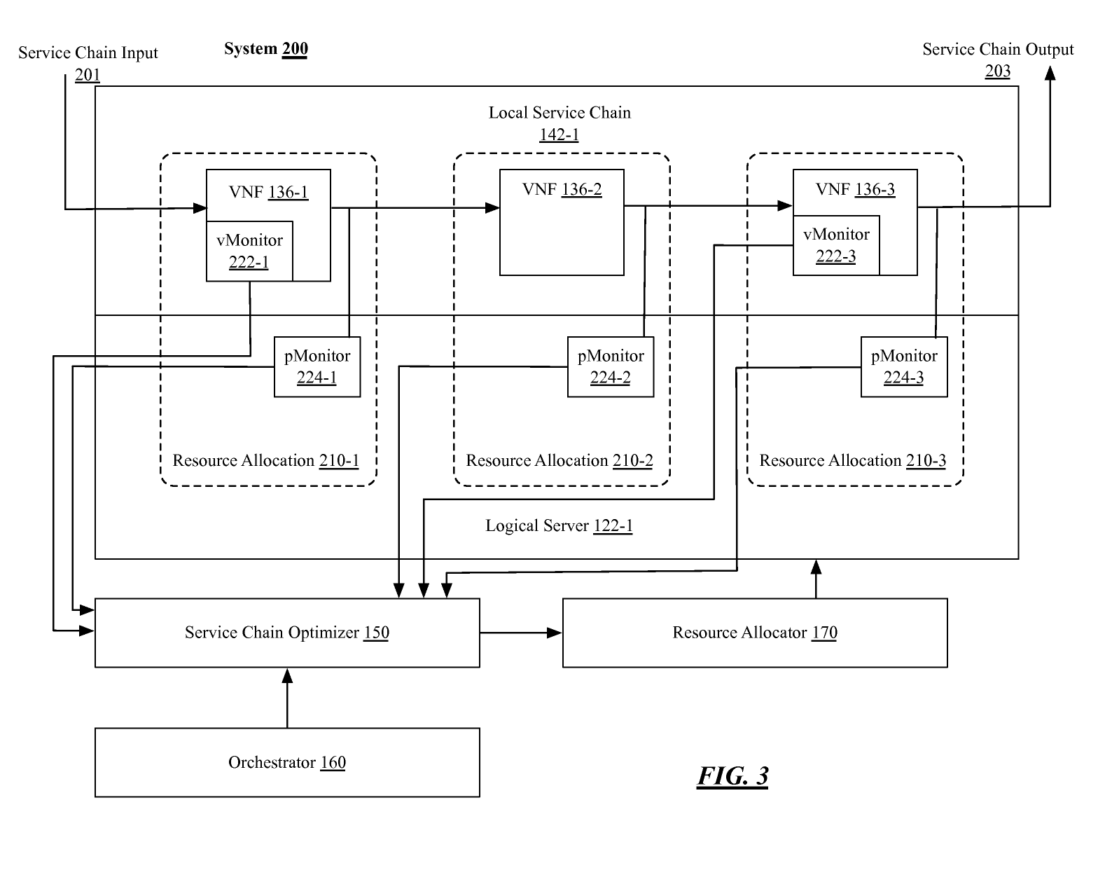

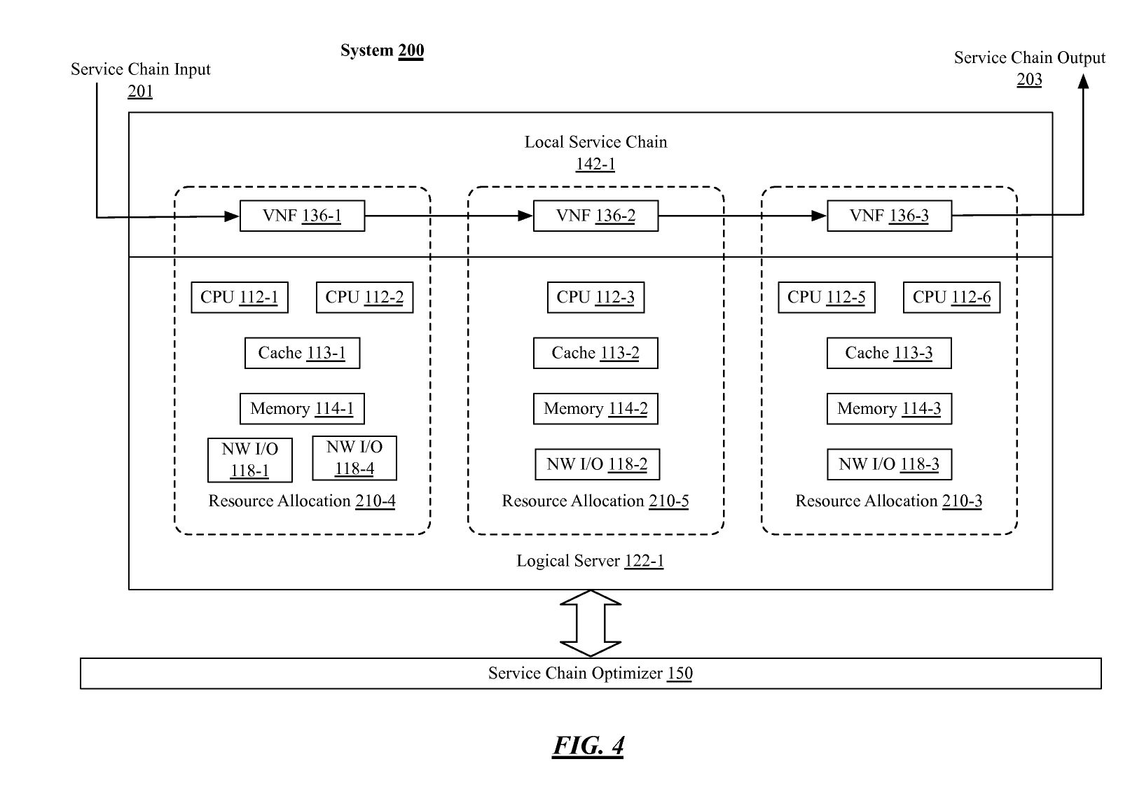

FIGS. 2-4 illustrate an example second system 200. It is important to note, that the example second system 200 is described with reference to portions of the example system 100 shown in FIG. 1. This is done for purposes of conciseness and clarity. However, the example system 200 can be implemented with different elements that those discussed above with respect to the system 100. As such, the reference to FIG. 1 is not to be limiting. In general, these figures show the system 200 comprising the local service chain 142-1. In particular, FIG. 2 shows the local service chain 142-1 and first resource allocations 210-a for each of the virtual elements of the service chain; while FIG. 3 shows the local service chain 142 in greater detail including various performance monitors configured to monitor the performance of the virtual elements of the service chain and the data throughput of the service chain; while FIG. 4 shows the local service chain 142-1 and second resource allocations 210-a for the virtual elements of the service chain that may be provided by the SCO 150 based on information received from the performance monitors shown in FIG. 3.

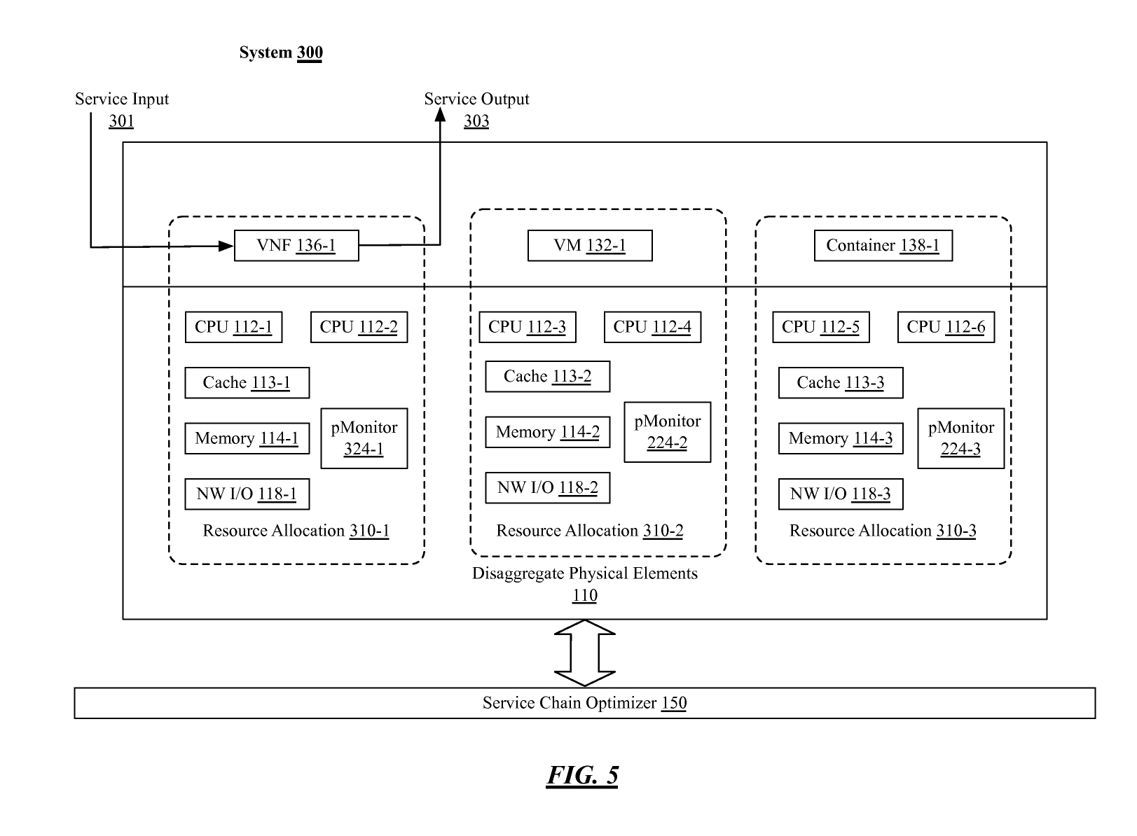

Turning more specifically to FIG. 2, the local service chain 142-1 is depicted including VNFs 136-1 to 136-3. Furthermore, a service chain input 201 and service chain output 203 showing a data path through the local service chain 142-1 is depicted. The local service chain 142-1 may be implemented on logical server 122-1. It is important to note, that although the examples provided here show a local service chain implemented on a logical server, this is not to be limiting. More specifically, the present disclose can be applied to service chains that span more than one logical server and or are implemented in a cloud infrastructure formed from disaggregate physical elements (refer to FIG. 5). However, a local service chain is used in this example for purposes of clarity and ease of explanation.

Each virtual element of the service chain 142-1 is depicted having a resource allocation 210-a. The resource allocations 210-a correspond to portions of disaggregate physical elements 110 used to implement the logical server 122-1. More particularly, resource allocations 210-a correspond to portions of disaggregate physical elements 110 used to implement each virtual element (e.g., VNFs 136-a, or the like) of the local service chain 142-1.

For example, a resource allocation 210-1 is shown including CPU 112-1, CPU 112-2, Cache 113-1, Memory 114-1, and N/W IO 118-1. The resource allocation 210-1 is further shown supporting the VNF 136-1. Resource allocation 210-2 is shown including CPU 112-3, CPU 112-4, Cache 113-2, Memory 114-2, and N/W IO 118-2. The resource allocation 210-2 is further shown supporting the VNF 136-2. Resource allocation 210-3 is shown including CPU 112-5, CPU 112-6, Cache 113-3, Memory 114-3, and N/W IO 118-3. The resource allocation 210-3 is further shown supporting the VNF 136-3.

Turning more specifically to FIG. 3, the system 200 is shown including monitors implemented in the system 200. Additionally, an orchestrator 160 and a resource allocator 170 are shown. In general, the orchestrator 160 is configured to implement policies and manage the overall system 100 and more particularly the cloud infrastructure in which the local service chain 142-1 can be implemented. The resource allocator 170 is configured to allocate various portions of disaggregate physical elements 110 to support the local service chain and more particularly to assign specific resources to support specific virtual elements.

The system 200 can further include performance monitors. In particular, the system 200 can include virtual performance monitors (vMonitor) 222-a and physical performance monitors (pMonitor) 224-a. In general, the vMonitors 222-a can be implemented to monitor performance internal to the virtual elements while the pMonitors 224-a can be implemented to monitor performance external to the virtual elements. With some examples, a given vMonitor 222-a can be configured to monitor the queue depth of a buffer, monitor the number of threads waiting to be executed, or the like. For example, the VNF 136-1 is depicted including the vMonitor 222-1. The vMonitor 222-1 can be implemented as part of the VNF 136-1 or may be implemented external to (e.g., as a separate virtual element, or the like) but configured to monitor performance internal to the VNF 136-1. More particularly, if the virtual element is a propriety element (e.g., a proprietary virtual function for intrusion detection, or the like) the vendor of the VNF may include a vMonitor to facilitate reporting of performance as described herein. In some examples, if the virtual element is implemented as a container, the cloud infrastructure may include vMonitors 222-a configured to monitor the internal operation of the container. For example, the VNF 136-3 may be implemented as a container (e.g., one of container 138-a) and the vMonitor 222-2 implemented to monitor various buffers, registers, queues, stacks, or the like internal to the container.

With some examples, the pMonitors 224-a are configured to monitor the performance of the data flow through the service chain (e.g., from input 201 to output 203) and particularly at each point between the virtual elements of the service chain. Furthermore, the pMonitors 224-a can be configured to monitor the performance of disaggregate physical elements 110 supporting the virtual elements. For example, the pMonitors 224-1, 224-2, and 224-3 are configured to monitor corresponding resource allocations 210-a and portions of the data path through the service local service chain 142-1. In some examples, the pMonitors 224-a can be configured to monitor various data processing portions (e.g., vSwitches 134-a, N/W IO 118-a, a shared memory, or the like) of the system 200 to monitor data flow (e.g., throughput, or the like) through the local service chain 142-1 to identify virtual elements that may correspond to a bottleneck in the system. With some examples, pMonitors 224-a can be configured to monitor other portions of the logical server 122-1 or disaggregate physical elements 110 implementing the logical server 122-1. For example, a given pMonitor 224-a can be configured to monitor cache misses, CPU utilization, memory utilization, or the like for a resource allocation 210-a.

The SCO 150 can be configured to receive performance information for the service chain 142-1. In particular, the SCO 150 can be configured to receive performance information from the vMonitors 22-a and the pMonitors 224-a, the performance information to include indications of the performance of the various virtual elements forming the local service chain 142-1. For example, the SCO 150 can receive performance information for the VNF 136-1 from the vMonotor 222-1 and the pMonitor 224-1. Additionally, the SCO 150 can receive performance information for the VNF 136-2 from the pMonitor 224-2. Furthermore, the SCO 150 can receive performance information for the VNF 136-3 from the vMonotor 222-2 and the pMonitor 224-3.

Additionally, the SCO 150 can determine a resource allocation (e.g., resource allocations 210-a) or an adjustment to a resource allocation (refer to FIG. 4) based on the received information. In general, the SCO 150 can determine an allocation or an adjustment to an allocation based on a particular policy or “goal,” which may be received from the orchestrator 160. For example, the SCO 150 can determine an allocation or adjustment to an allocation to minimize power consumption of the system 200 and/or the local service chain 142-1. The SCO 150 can determine an allocation or adjustment to an allocation 150 to minimize memory usage of the system 200 and/or the local service chain 142-1. The SCO 150 can determine an allocation or adjustment to an allocation 150 to maximize throughput of the system 200 and/or the local service chain 142-1. The SCO 150 can determine an allocation or adjustment to an allocation 150 to maximize computational power or the system 200 and/or the local service chain 142-1.

Turning more particularly to FIG. 4, the system 200 is shown with an adjusted resource allocation. In particular, the resource allocations 210-4, 210-5, and 210-3 are shown. Specifically, the resource allocation 210-1 which is shown supporting the VNF 136-1 in FIGS. 2-3 is shown replaced or adjusted with resource allocation 210-4; the resource allocation 210-2 which is shown supporting the VNF 136-2 in FIGS. 2-3 is shown replaced or adjusted with resource allocation 210-5; the resource allocation 210-3 which is shown supporting the VNF 136-3 in FIGS. 2-3 is shown the same (or unadjusted) in FIG. 4.

In some examples, the SCO 150 can be configured to determine an adjustment to make to a resource allocation. With some examples, the SCO 150 can determine that processing power needs to be increased or decreased. For example, if the policy specifies that power is to be conserved, and the performance information indicates that the CPUs 112-a are underutilized (e.g., based on the pMonitor 224-a monitoring the C-states of the CPU's 112-a, or the like) in a given VNF 136-a, the SCO 150 can determine that the resource allocation for the given VNF 136-a be adjusted to comprise less computing power (e.g. less CPUs 112-a). For example, the resource allocation 210-5 includes less CPUs 112-a than the resource allocation 210-2 but supports the same VNF 136-a in the system 200.

In some examples, if the policy specifies that network throughput is to be maximized and the performance information indicates that a given VNF 136-a is maximizing (e.g., based on monitoring the vSwitches 134-a, the N/W IO elements 118-a, or the like) its allocated network bandwidth, the SCO 150 can determine that the resource allocation for the given VNF 136-a be adjusted to increase network bandwidth, thereby increasing overall throughput through the service chain. For example, the resource allocation 210-4 includes less more N/W IOs 118-a than the resource allocation 210-1 but supports the same VNF 136-a in the system 200.

It is important to note, that the present disclose can be implemented to optimize performance of a virtual element that is not part of a service chain. Additionally, the present disclosure can be implemented to optimize performance of a service chain or a virtual element supported by a cloud infrastructure implemented across logical servers. FIG. 5 depicts a third example system 300. The system 300 includes VNF 136-1 having data path from input 301 to output 303 through the VNF 136-1. Furthermore, the system 300 includes VM 132-1 and container 138-1. The VNF 136-1, VM 132-1 and container 138-1 are supported by disaggregate physical elements 110 and particularly by resource allocations 310-a of disaggregate physical elements 110. For example, VNF 136-1 is depicted supported by resource allocation 310-1, VM 132-1 is depicted supported by resource allocation 310-2 and container 138-1 is depicted supported by resource allocation 310-3. The SCO 150 can be configured to receive performance information from monitors (e.g., vMonitors, pMonitors, or the like) implemented within the system 300 to allocate or adjust an allocation or disaggregate physical elements 110 to optimize the performance of the VNF 136-1. For example, pMonitors 324-a can be implemented in the system 300 to monitor the performance of disaggregate physical elements 110. Additionally the VNF 136-1 and/or the other virtual elements of the system 300 may have vMonitors (refer to FIGS. 2-4) implemented to monitor internal performance of the virtual elements of the system 300.

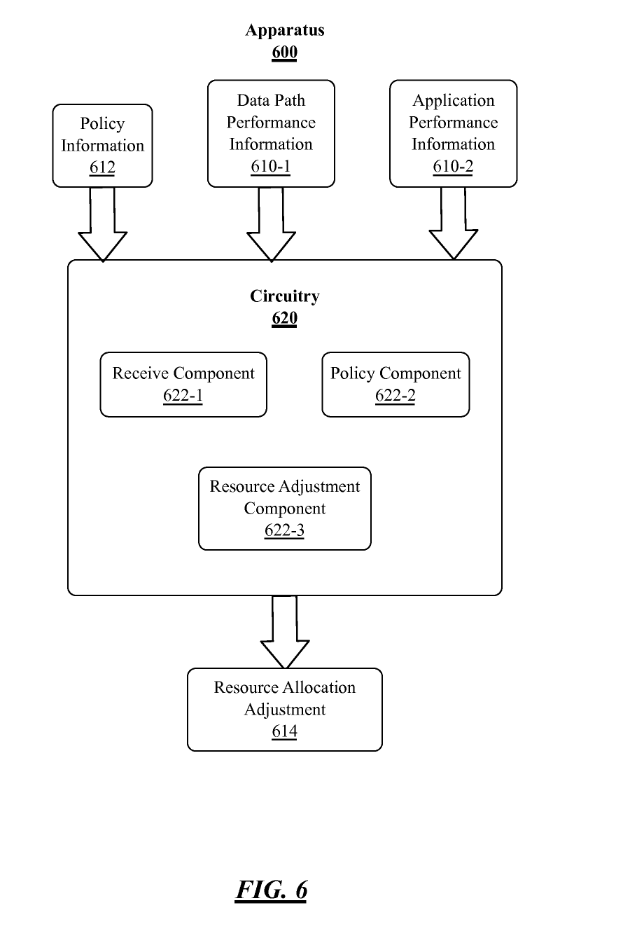

FIG. 6 illustrates an example block diagram for apparatus 600. Although apparatus 600 shown in FIG. 6 has a limited number of elements in a certain topology, it may be appreciated that the apparatus 600 may include more or less elements in alternate topologies as desired for a given implementation.

According to some examples, apparatus 600 may be supported by circuitry 620 maintained at or with management elements for a system including a shared pool of configurable computing resources such as SCO 150 shown in FIGS. 1-5 for system 100, 200, and/or 300. Circuitry 620 may be arranged to execute one or more software or firmware implemented modules or components 622-a. It is worthy to note that “a” and “b” and “c” and similar designators as used herein are intended to be variables representing any positive integer. Thus, for example, if an implementation sets a value for a=3, then a complete set of software or firmware for components 622-a may include components 622-1, 622-2 or 622-3. The examples presented are not limited in this context and the different variables used throughout may represent the same or different integer values. Also, these “components” may be software/firmware stored in computer-readable media, and although the components are shown in FIG. 6 as discrete boxes, this does not limit these components to storage in distinct computer-readable media components (e.g., a separate memory, etc.).

According to some examples, circuitry 620 may include a processor, processor circuit or processor circuitry. Circuitry 620 may be part of host processor circuitry that supports a management element for cloud infrastructure such as SCO 150. Circuitry 620 may be generally arranged to execute one or more software components 622-a. Circuitry 620 may be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 620 may also include an application specific integrated circuit (ASIC) and at least some components 622-a may be implemented as hardware elements of the ASIC.

In some examples, apparatus 600 may include a receive component 622-1. Receive component 622-1 may be executed by circuitry 620 to receive information for a network service being provided using a shared pool of configurable computing resources, the network service including service chains and/or local service chains. In general, the receive component 622-1 may include a radio transceiver, radio frequency transceiver, a receiver interface, and/or software executed by circuitry 620 to receive information as described herein. For these examples, information 610-a may include the received information. In particular, information 610-a may data path performance information 610-1 and/or application performance information 610-2. The data path performance information 610-1 may correspond to information received from pMonitors while the application performance information 610-2 may correspond to information received from vMonitors.

According to some examples, apparatus 600 may also include a policy component 622-2. Policy component 622-2 may be executed by circuitry 620 to receive policy information 612. The policy information 612 may include indications of a policy or goal for which performance of the system to which the apparatus 600 is configured to manage be optimized. In particular, the policy information may include indications of an optimization goal for a given service chain, local service chain, and/or virtual element implemented using a shares set of configurable computing resources (e.g., the system 100, 200, and/or 300).

Apparatus 600 may also include a resource adjustment component 622-3. Resource adjustment component 622-3 may be executed by circuitry 620 to determine resource allocation adjustment 613. In particular, resource adjustment component 622-3 can determine an allocation or an adjustment to an allocation of resources supporting a virtual element. For these examples, resource adjustment component 622-3 may use data path performance information 610-1 and/or application performance information 610-2 as well as policy information 612 to determine the resource allocation or adjustment to resource allocation to optimize the performance of the virtual element(s) of a service chain according to the policy indicated in the policy information 612.

Various components of apparatus 600 and a device, node or logical server implementing apparatus 600 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

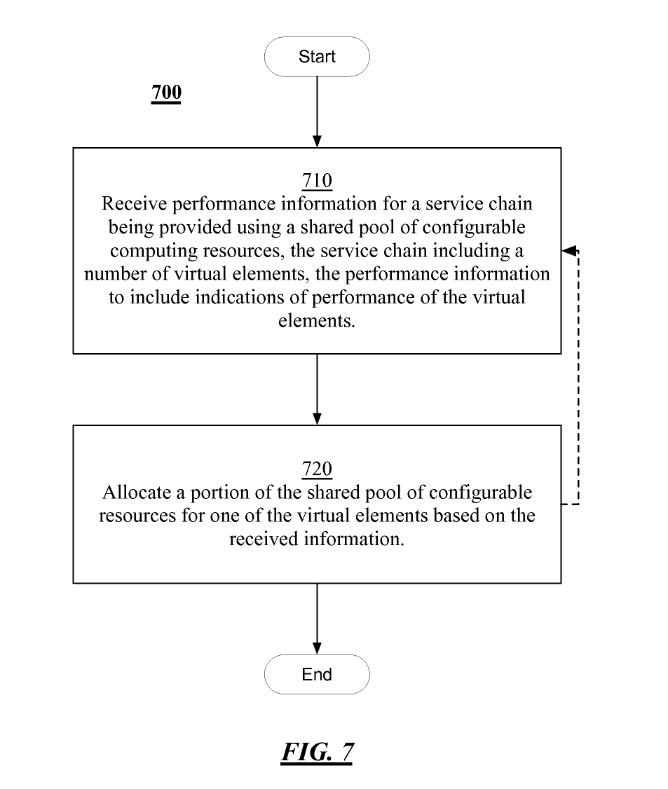

FIG. 7 illustrates an example logic flow 700. Logic flow 700 may be representative of some or all of the operations executed by one or more logic, features, or devices described herein, such as apparatus 600. More particularly, logic flow 700 may be implemented by at least receive component 622-1 or the resource adjustment component 622-3.

According to some examples, logic flow 700 at block 710 may receive performance information for a service chain being provided using a shared pool of configurable computing resources, the service chain including a number of virtual elements, the performance information to include indications of performance of the virtual elements. For example, the receive component 622-1 may receive the performance information, such as, data path performance information 610-1 and/or virtual performance information 610-2.

In some examples, logic flow 700 at block 720 may allocate a portion of the shared pool of configurable resources for one of the virtual elements based on the received information. For example, the resource adjustment component 622-3 may determine a resource allocation, determine an adjustment to make to a resource allocation, or allocate, With some examples, the resource adjustment component 622-3 may determine resource allocation adjustment 614 based on the received information to optimize performance (e.g., power, throughput, etc.) of the service chain.

Furthermore, it is important to note, that the present disclosure may be implemented to adjust resource allocation for a service chain dynamically (e.g., during operation of the system implementing the service chain). Accordingly, logic flow 700 may be repeated (e.g., iteratively, periodically, or the like) to adjust the resource allocation based on repeatedly receiving performance information (e.g., at block 710) and repeatedly adjusting resource allocations (e.g., at block 720). As such, the logic flow 700 can be implemented to optimize performance of a service chain during operation to account for changing conditions (e.g. network data, computational requirements, or the like).

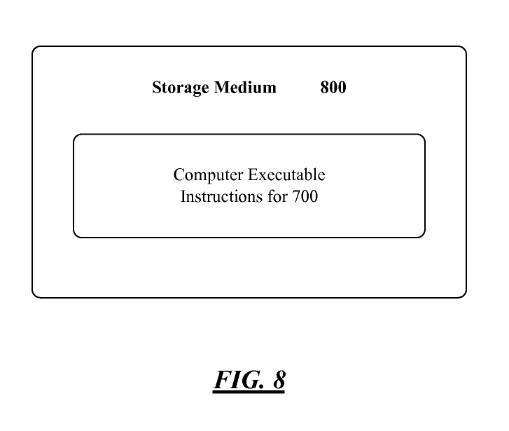

FIG. 8 illustrates an example storage medium 800. As shown in FIG. 8, the first storage medium includes a storage medium 800. The storage medium 800 may comprise an article of manufacture. In some examples, storage medium 800 may include any non-transitory computer readable medium or machine readable medium, such as an optical, magnetic or semiconductor storage. Storage medium 800 may store various types of computer executable instructions, such as instructions to implement logic flow 700. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

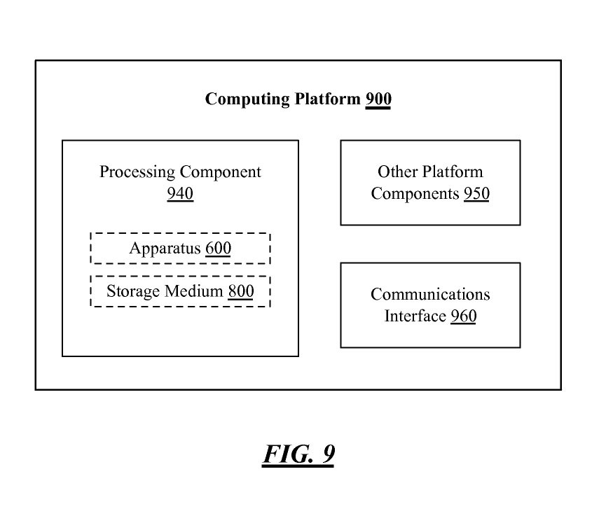

FIG. 9 illustrates an example computing platform 900. In some examples, as shown in FIG. 9, computing platform 900 may include a processing component 940, other platform components 950 or a communications interface 960. According to some examples, computing platform 900 may host management elements (e.g., cloud infrastructure orchestrator, network data center service chain orchestrator, or the like) providing management functionality for a system having a shared pool of configurable computing resources such as system 100 of FIG. 1, system 200 of FIGS. 2-4, or system 300 of FIG. 5. Computing platform 900 may either be a single physical server or a composed logical server that includes combinations of disaggregate components or elements composed from a shared pool of configurable computing resources.

According to some examples, processing component 940 may execute processing operations or logic for apparatus 600 and/or storage medium 800. Processing component 940 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 950 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 960 may include logic and/or features to support a communication interface. For these examples, communications interface 960 may include one or more communication interfaces that operate according to various communication protocols or standards to communicate over direct or network communication links. Direct communications may occur via use of communication protocols or standards described in one or more industry standards (including progenies and variants) such as those associated with the PCIe specification. Network communications may occur via use of communication protocols or standards such those described in one or more Ethernet standards promulgated by IEEE. For example, one such Ethernet standard may include IEEE 802.3. Network communication may also occur according to one or more OpenFlow specifications such as the OpenFlow Hardware Abstraction API Specification. Network communications may also occur according to the Infiniband Architecture specification or the TCP/IP protocol.

As mentioned above computing platform 900 may be implemented in a single server or a logical server made up of composed disaggregate components or elements for a shared pool of configurable computing resources. Accordingly, functions and/or specific configurations of computing platform 900 described herein, may be included or omitted in various embodiments of computing platform 900, as suitably desired for a physical or logical server.

The components and features of computing platform 900 may be implemented using any combination of discrete circuitry, application specific integrated circuits (ASICs), logic gates and/or single chip architectures. Further, the features of computing platform 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

### Example 1

An apparatus to optimize performance of a virtual element supported by a cloud infrastructure, the apparatus comprising: circuitry; a receive component for execution by the circuitry to receive performance information for a service chain being provided using a shared pool of configurable computing resources, the service chain including a plurality of virtual elements, the performance information to include indications of performance of the plurality of virtual elements; and a resource adjustment component for execution by the circuitry to allocate a portion of the shared pool of configurable resources for a one of the plurality of virtual elements based on the received information.

### Example 2

The apparatus of example 1, the portion of the shared pool of configurable resources a first portion and the one of the plurality of virtual element a first one, the resource adjustment component to allocate a second portion of the shared pool of configurable resources for a second one of the plurality of virtual elements based on the received information.

### Example 3

The apparatus of example 1, the resource adjustment component to adjust an allocation of the portion of the shared pool of configurable resources for the one of the plurality of virtual elements based on the received information.

### Example 4

The apparatus of example 1, comprising a policy component to receive policy information, the policy information to include an indication of a performance goal.

### Example 5

The apparatus of example 4, the resource adjustment component to allocate the portion of the shared pool of configurable resources based on the received performance information and the received policy information.

### Example 6

The apparatus of example 4, the performance goal comprising minimizing power consumption, minimizing memory usage, maximizing throughput, or maximizing computational power.

### Example 7

The apparatus of example 4, the policy comprising a service level agreement for a customer of the cloud infrastructure.

### Example 8

The apparatus of example 1, the received performance information comprising virtual performance information, the virtual performance information to include indications of performance of the virtual element.

### Example 9

The apparatus of example 8, the performance of the virtual element comprising queue depth of an internal buffer or threads waiting to be executed.

### Example 10

The apparatus of example 1, the received performance information comprising physical performance information, the physical performance information to include indications of performance of the portion of the shared pool of configurable resources.

### Example 11

The apparatus of example 10, the performance of the portion of the shared pool of configurable resources comprising processor utilization, memory utilization, cache misses or data throughput.

### Example 12

The apparatus of any one of examples 4 to 7, the portion of the shared pool of configurable resources a first portion and the one of the plurality of virtual element a first one, the resource adjustment component to increase the first portion of the pool of configurable computing resources and to decrease a second portion of the shared pool of configurable resources, the second portion of the shared pool of computing resources for a second one of the plurality of virtual elements.

### Example 13

The apparatus of any one of examples 1 to 11, the plurality of virtual elements comprising virtual network functions, virtual machines, or containers.

### Example 14

The apparatus of any one of examples 1 to 11, the shared pool of configurable computing resources comprising disaggregate physical elements including central processing units, memory devices, storage devices, network input/output devices or network switches.

### Example 15

The apparatus of any one of examples 1 to 11, comprising a digital display coupled to the circuitry to present a user interface view.

### Example 16

A method comprising: receiving performance information for a service chain being provided using a shared pool of configurable computing resources, the service chain including a plurality of virtual elements, the performance information to include indications of performance of the plurality of virtual elements; and allocating a portion of the shared pool of configurable resources for a one of the plurality of virtual elements based on the received information.

### Example 17

The method of example 16, the portion of the shared pool of configurable resources a first portion and the one of the plurality of virtual element a first one, the method comprising allocating a second portion of the shared pool of configurable resources for a second one of the plurality of virtual elements based on the received information.

### Example 18

The method of example 16, comprising adjusting an allocation of the portion of the shared pool of configurable resources for the one of the plurality of virtual elements based on the received information.

### Example 19

The method of example 16, comprising receiving policy information, the policy information to include an indication of a performance goal.

### Example 20

The method of example 19, comprising allocating the portion of the shared pool of configurable resources based on the received performance information and the received policy information.

### Example 21

The method of example 19, the performance goal comprising minimizing power consumption, minimizing memory usage, maximizing throughput, or maximizing computational power.

### Example 22

The method of example 16, the received performance information comprising virtual performance information, the virtual performance information to include indications of performance of the virtual element.

### Example 23

The method of example 22, the performance of the virtual element comprising queue depth of an internal buffer or threads waiting to be executed.

### Example 24

The method of example 16, the received performance information comprising physical performance information, the physical performance information to include indications of performance of the portion of the shared pool of configurable resources.

### Example 25

The method of example 24, the performance of the portion of the shared pool of configurable resources comprising processor utilization, memory utilization, cache misses or data throughput.

### Example 26

The method of any one of examples 19 to 21, the portion of the shared pool of configurable resources a first portion and the one of the plurality of virtual element a first one, the method comprising increasing the first portion of the pool of configurable computing resources and decreasing a second portion of the shared pool of configurable resources, the second portion of the shared pool of computing resources for a second one of the plurality of virtual elements.

### Example 27

The method of any one of examples 16 to 25, the plurality of virtual elements comprising virtual network functions, virtual machines, or containers.

### Example 28

The method of any one of examples 16 to 25, the shared pool of configurable computing resources comprising disaggregate physical elements including central processing units, memory devices, storage devices, network input/output devices or network switches.

### Example 29

At least one machine readable medium comprising a plurality of instructions that in response to being executed by system at a server cause the system to carry out a method according to any one of examples 16 to 28.

### Example 30

An apparatus comprising means for performing the methods of any one of examples 16 to 28.

### Example 31

At least one machine readable medium comprising a plurality of instructions that in response to being executed by a system cause the system to: receive, at a processor circuit, performance information for a service chain being provided using a shared pool of configurable computing resources, the service chain including a plurality of virtual elements, the performance information to include indications of performance of the plurality of virtual elements; and allocate a portion of the shared pool of configurable resources for a one of the plurality of virtual elements based on the received information.

### Example 32

The at least one machine readable medium of example 31, the portion of the shared pool of configurable resources a first portion and the one of the plurality of virtual element a first one, the plurality of instructions causing the system to allocate a second portion of the shared pool of configurable resources for a second one of the plurality of virtual elements based on the received information.

### Example 33

The at least one machine readable medium of example 31, the plurality of instructions causing the system to adjust an allocation of the portion of the shared pool of configurable resources for the one of the plurality of virtual elements based on the received information.

### Example 34

The at least one machine readable medium of example 31, the plurality of instructions causing the system to receive policy information, the policy information to include an indication of a performance goal.

### Example 35

The at least one machine readable medium of example 34, the plurality of instructions causing the system to allocate the portion of the shared pool of configurable resources based on the received performance information and the received policy information.

### Example 36

The at least one machine readable medium of example 34, the performance goal comprising minimizing power consumption, minimizing memory usage, maximizing throughput, or maximizing computational power.

### Example 37

The at least one machine readable medium of example 31, the received performance information comprising virtual performance information, the virtual performance information to include indications of performance of the virtual element.

### Example 38

The at least one machine readable medium of example 37, the performance of the virtual element comprising queue depth of an internal buffer or threads waiting to be executed.

### Example 39

The at least one machine readable medium of example 31, the received performance information comprising physical performance information, the physical performance information to include indications of performance of the portion of the shared pool of configurable resources.

### Example 40

The at least one machine readable medium of example 39, the performance of the portion of the shared pool of configurable resources comprising processor utilization, memory utilization, cache misses or data throughput.

### Example 41

The at least one machine readable medium of any one of examples 37 to 39, the portion of the shared pool of configurable resources a first portion and the one of the plurality of virtual element a first one, the plurality of instructions causing the system to increase the first portion of the pool of configurable computing resources and decrease a second portion of the shared pool of configurable resources, the second portion of the shared pool of computing resources for a second one of the plurality of virtual elements.

### Example 42

The at least one machine readable medium of any one of examples 31 to 40, the plurality of virtual elements comprising virtual network functions, virtual machines, or containers.

### Example 43

The at least one machine readable medium of any one of examples 31 to 40, the shared pool of configurable computing resources comprising disaggregate physical elements including central processing units, memory devices, storage devices, network input/output devices or network switches.

What is claimed is:

1. An apparatus to optimize performance of a virtual element the apparatus comprising:
circuitry;
a receive component for execution by the circuitry to receive performance information for a service chain to be provided using a shared pool of configurable computing resources, the service chain including a plurality of virtual elements, the performance information to include indications of performance of the plurality of virtual elements; and
a resource adjustment component for execution by the circuitry to allocate a portion of the shared pool of configurable resources for a one of the plurality of virtual elements based on the received information.

2. The apparatus of claim 1, the portion of the shared pool of configurable resources a first portion and the one of the plurality of virtual element a first one, the resource adjustment component to allocate a second portion of the shared pool of configurable resources for a second one of the plurality of virtual elements based on the received information.

3. The apparatus of claim 1, the resource adjustment component to adjust an allocation of the portion of the shared pool of configurable resources for the one of the plurality of virtual elements based on the received information.

4. The apparatus of claim 1, comprising a policy component to receive policy information, the policy information to include an indication of a performance goal.

5. The apparatus of claim 4, the resource adjustment component to allocate the portion of the shared pool of configurable resources based on the received performance information and the received policy information.

6. The apparatus of claim 4, the performance goal comprising minimizing power consumption, minimizing memory usage, maximizing throughput, or maximizing computational power.

7. The apparatus of claim 4, the policy comprising a service level agreement for a customer of the cloud infrastructure.

8. The apparatus of claim 1, the received performance information comprising virtual performance information, the virtual performance information to include indications of performance of the virtual element.

9. The apparatus of claim 8, the performance of the virtual element comprising queue depth of an internal buffer or threads waiting to be executed.

10. The apparatus of claim 1, the received performance information comprising physical performance information, the physical performance information to include indications of performance of the portion of the shared pool of configurable resources.

11. The apparatus of claim 10, the performance of the portion of the shared pool of configurable resources comprising processor utilization, memory utilization, cache misses or data throughput.

12. The apparatus of claim 4, the portion of the shared pool of configurable resources a first portion and the one of the plurality of virtual element a first one, the resource adjustment component to increase the first portion of the pool of configurable computing resources and to decrease a second portion of the shared pool of configurable resources, the second portion of the shared pool of computing resources for a second one of the plurality of virtual elements.

13. The apparatus of claim 1, the plurality of virtual elements comprising virtual network functions, virtual machines, or containers.

14. The apparatus of claim 1, the shared pool of configurable computing resources comprising disaggregate physical elements including central processing units, memory devices, storage devices, network input/output devices or network switches.

15. The apparatus of claim 1, comprising a digital display coupled to the circuitry to present a user interface view.

16. A method comprising:
receiving performance information for a service chain to be provided using a shared pool of configurable computing resources, the service chain including a plurality of virtual elements, the performance information to include indications of performance of the plurality of virtual elements; and
allocating a portion of the shared pool of configurable resources for a one of the plurality of virtual elements based on the received information.

17. The method of claim 16, the portion of the shared pool of configurable resources a first portion and the one of the plurality of virtual element a first one, the method comprising allocating a second portion of the shared pool of configurable resources for a second one of the plurality of virtual elements based on the received information.

18. The method of claim 16, comprising adjusting an allocation of the portion of the shared pool of configurable resources for the one of the plurality of virtual elements based on the received information.

19. The method of claim 16, comprising receiving policy information, the policy information to include an indication of a performance goal.

20. The method of claim 19, comprising allocating the portion of the shared pool of configurable resources based on the received performance information and the received policy information.

21. The method of claim 19, the performance goal comprising minimizing power consumption, minimizing memory usage, maximizing throughput, or maximizing computational power.

22. At least one machine readable medium comprising a plurality of instructions that in response to being executed by a system cause the system to:
receive, at a processor circuit, performance information for a service chain to be provided using a shared pool of configurable computing resources, the service chain including a plurality of virtual elements, the performance information to include indications of performance of the plurality of virtual elements; and
adjust an allocation of a portion of the shared pool of configurable resources for a one of the plurality of virtual elements based on the received information.

23. The at least one machine readable medium of claim 22, the plurality of instructions causing the system to allocate the portion of the shared pool of configurable resources based on the received performance information and a policy information, the policy information to include an indication of a performance goal.

24. The at least one machine readable medium of claim 22, the received performance information comprising virtual performance information, the virtual performance information to include indications of performance of the virtual element, the performance of the virtual element comprising queue depth of an internal buffer or threads waiting to be executed.

25. The at least one machine readable medium of claim 22, the received performance information comprising physical performance information, the physical performance information to include indications of performance of the portion of the shared pool of configurable resources, the performance of the portion of the shared pool of configurable resources comprising processor utilization, memory utilization, cache misses or data throughput.
